(19) United States
(12) Patent Application Publication
(10) Pub. No.: US 2025/0112309 A1
(43) Pub. Date: Apr. 3, 2025

(54) STRUCTURAL FEATURES FOR BATTERY CELLS

(71) Applicant: Rivian IP Holdings, LLC, Irvine, CA (US)

(72) Inventors: Abigail Elizabeth WUCHERER, Belmont, NC (US); Rajeev DHIMAN, Pleasanton, CA (US); Meng WANG, Pleasanton, CA (US); Debaditya BISWAS, San Jose, CA (US); Daniel Matthew DAVIES, San Francisco, CA (US); Alexandra SCHWARTZ, Tahoe City, CA (US); Kenton Robert HARRIS, Bloomington, IL (US)

(21) Appl. No.: 18/900,458

(22) Filed: Sep. 27, 2024

Related U.S. Application Data
(60) Provisional application No. 63/587,106, filed on Sep. 30, 2023.
(60) Provisional application No. 63/592,890, filed on Oct. 24, 2023.
(60) Provisional application No. 63/593,945, filed on Oct. 27, 2023.

(51) Int. Cl. H01M 50/211; H01M 10/613; H01M 10/625; H01M 10/653; H01M 50/224; H01M 50/249

(52) U.S. Cl. CPC H01M 50/211; H01M 10/613; H01M 10/625; H01M 10/653; H01M 50/224; H01M 50/249; H01M 2220/20

(57) ABSTRACT

A structural member for a battery cell may be provided in the form of an I-beam having a central support structure that extends through the middle of the battery cell. One or more electrode stacks may be provided within one or more cavities defined by the structural member. The structural member may provide mechanical, structural, and/or thermal benefits for the battery cell and/or one or more battery sub-assemblies, battery modules, and/or battery packs. A battery cell includes a contoured housing with curved lateral surfaces conforming to a shape of one or more wound electrode layers. When the wound electrode layers are inserted into the contoured housing, space between the electrode layers and the contoured housing is reduced, as compared to that of square or rectangular housings, leading to higher wetting rate and lower wetting times of the wound electrode layers, higher structural loading, wider tolerances, and/or flexible cooling strategies.

### CROSS REFERENCE TO RELATED APPLICATION(S)

This application claims the benefit of U.S. Provisional Application No. 63/587,106, entitled “CONTOURED PRISMATIC CELL,” filed Sep. 30, 2023, U.S. Provisional Application No. 63/592,890, entitled “STRUCTURAL BATTERY CELL,” filed Oct. 24, 2023, and U.S. Provisional Application No. 63/593,945, entitled “STRUCTURAL BATTERY CELL,” filed Oct. 27, 2023, the entirety of each is incorporated herein by reference.

### INTRODUCTION

Batteries are often used as a source of power, including as a source of power for electric vehicles that include wheels that are driven by an electric motor that receives power from the battery.

Aspects of the subject technology can help to improve the reliability and performance of battery cells, including battery cells for electric vehicles, which can help to mitigate climate change by reducing greenhouse gas emissions.

### SUMMARY

Aspects of the subject technology relate to a structural member for a battery cell, such as a prismatic battery cell. The structural member may include a central support structure configured to extend through the middle of the battery cell, and two flanges at opposing ends of the central support structure, which form an I-beam. The two flanges may form top and bottom surfaces of a cell housing. The cell housing may also include a shell (e.g., a single shell that slides over the I-beam or two C-shells) and/or a flexible sealing membrane that forms the remaining surfaces of the cell housing. Electrode stacks can be provided along the central support structure and between portions of the two flanges. Providing a battery cell with a structural member as described herein may help to (i) form a structural cell that acts as a load-bearing member in a battery pack, and provides stiffness and/or energy-absorption during normal vehicle operation and/or impact events, (ii) provide improved thermal management for the battery cell, (iii) maintain structural integrity in the presence of cell swelling, and/or (iv) facilitate a compact arrangement with double the voltage by, for example, providing a hermetically-sealed cell on each side of the central support structure. In one or more implementations, a battery cell includes a contoured housing for a wound electrode stack. For example, the contoured housing may include multiple curved surfaces designed to conform, or at least substantially conform, to a shape of several rolled, or wound, electrode layers. By using a contoured housing with curved surfaces, the amount of space, or volume, between the contoured housing and the electrode stack is reduced, as compared to square or rectangular housings. Beneficially, the wetting rate of the electrode layers may increase, resulting in lower wetting times and improved battery cell performance.

In accordance with aspects of the subject technology, an apparatus is provided that includes a structural member for a battery cell, the structural member including a central support structure, a first flange at a first end of the central support structure, and a second flange at a second end of the central support structure. The structural member may be configured to receive a stack of electrodes within a cavity formed, in part, by the central support structure, a first portion of the first flange and a first portion of the second flange.

The structural member may be configured to receive an additional stack of electrodes within an additional cavity formed, in part, by the central support structure, a second portion of the first flange and a second portion of the second flange. The structural member may be configured to be electrically coupled to the stack of electrodes. The structural member may be configured electrically couple the stack of electrodes to the additional stack of electrodes.

The central support structure of the structural member may be configured to support a rolled stack of electrodes that wraps around the central support structure. The first flange may be configured to form a first surface of a cell housing for the battery cell, and the second flange may be configured to form a second surface of the cell housing for the battery cell. The central support structure may be formed from a thermally conductive material and may be configured to conduct heat generated by the stack of electrodes away from the stack of electrodes. The structural member may include an I-beam that is formed from aluminum or steel.

In accordance with aspects of the subject technology, a battery cell is provided that includes a structural member for a battery cell, the structural member including a central support structure, a first flange at a first end of the central support structure, and a second flange at a second end of the central support structure. The structural member may be configured to receive a stack of electrodes within a cavity formed, in part, by the central support structure, a first portion of the first flange and a first portion of the second flange.

The battery cell may also include the stack of electrodes disposed at least partially within the cavity. The battery cell may also include an additional electrode stack disposed within an additional cavity formed, in part, by the central support structure, a second portion of the first flange and a second portion of the second flange. The first flange may be configured to form a first surface of a cell housing for the battery cell, the second flange may be configured to form a second surface of the cell housing for the battery cell, and the battery cell may also include a housing structure attached to the structural member. The housing structure forms at least a third surface of the cell housing.

The first flange, the second flange, and the central support structure may be rigid structures, and the housing structure may include a flexible membrane that is attached to at least the first flange and the second flange. The housing structure may include a rectangular prism having an opening configured to slide over the structural member. The housing structure may include a pair of c-shaped shell structures configured to be welded to the structural member. The battery cell may also include a thermal control structure thermally coupled to the structural member. The central support structure may include a fluid pathway configured to receive a thermal control fluid therethrough.

In accordance with aspects of the subject technology, a battery pack is provided that includes a plurality of battery cells, each including a structural member having a central support structure, a first flange at a first end of the central support structure, and a second flange at a second end of the central support structure. The structural member may be configured to receive a stack of electrodes within a cavity formed, in part, by the central support structure, a first portion of the first flange and a first portion of the second flange. The plurality of battery cells may include a first plurality of battery cells aligned in a first direction, and a second plurality of battery cells aligned in a second direction different from the first direction.

The structural members of the battery cells of the first plurality of battery cells may be configured to distribute a force of an impact to the battery pack along the first direction, and the structural members of the battery cells of the second plurality of battery cells may be configured to distribute a force of an impact to the battery pack along the second direction. The first direction may be orthogonal to the second direction.

In accordance with one or more aspects of the disclosure, an apparatus is described. The apparatus may include one or more wound electrode layers. The apparatus may further include a housing configured to conform to the one or more wound electrode layers. The housing may include a first planar surface. The housing may further include a first curved surface extending from the first planar surface. The housing may further include a second planar surface. The first curved surface may extend from the second planar surface. The first planar surface may be parallel with respect to the second planar surface

The housing may further include a second curved surface. The second curved surface may extend from the second planar surface. The first curved surface is configured to conform to a first portion of the one or more wound electrode layers, and the second curved surface is configured to conform to a second portion of the one or more wound electrode layers. The first curved surface may include a semi-circle. The first planar surface may be separated from the second planar surface by a dimension that is twice a radius of the semi-circle. The housing may further include a first dimension, and a second dimension that is at least 30 times greater than the first dimension.

In accordance with one or more aspects of the disclosure, a vehicle is described. The vehicle may include a battery pack. The battery pack may include a first housing for a first battery cell. The battery pack may further include a second housing for a second battery cell. Each of the first housing and the second housing may include a first planar surface, and a first curved surface extending from the first planar surface.

The first battery cell may be laterally displaced with respect to the second battery cell. The first battery cell may be staggered with respect to the second battery cell. Each of the first housing and the second housing further may include a second planar surface, and the first curved surface may extend from the second planar surface. Each of the first housing and the second housing may further include a second curved surface, and the second curved surface may extend from the second planar surface.

The first curved surface of the first housing may be configured to conform to a first portion of the first battery cell, and the second curved surface of the first housing may be configured to conform to a second portion of the first battery cell. Each of the first housing and the second housing may further include a first dimension, and a second dimension that is at least 30 times greater than the first dimension. The vehicle may further include a cooling tube comprising a shape that conforms to the first curved surface.

In accordance with one or more aspects of the disclosure, a method is described. The method may include performing a first operation to bend a metal sheet to form at least a first curved surface and a second curved surface. The first curved surface and the second curved surface may conform to a shape of a wound battery cell. The method may further include performing a second operation to form at least a first planar surface and a second planar surface. The method may further include securing a first end of the metal sheet with a second end of the metal sheet. The first planar surface may be parallel with respect to the second planar surface.

The method may further include subsequent to securing the first end with the second end, providing the wound battery cell within a housing formed by the metal sheet. The method may further include securing the first end with the second end comprises welding the first end to the second end.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a cross-sectional perspective view of a battery cell having a structural member in accordance with one or more implementations.

FIG. 4 illustrates a perspective view of a structural member for a battery cell in accordance with one or more implementations.

FIG. 5 illustrates a cross-sectional view of a battery cell having a structural member in accordance with one or more implementations.

FIG. 6 illustrates an exploded perspective view of housing structures for a battery cell in accordance with one or more implementations.

FIG. 7 illustrates an exploded perspective view of other housing structures for a battery cell in accordance with one or more implementations.

FIG. 8 illustrates an exploded perspective view of yet other housing structures for a battery cell in accordance with one or more implementations.

FIG. 9 illustrates an exploded perspective view of components of a battery cell in accordance with one or more implementations.

FIGS. 10A-10E illustrate a battery cell having a structural member, in various stages of assembly, in accordance with one or more implementations.

FIGS. 11A and 11B illustrates a perspective view and a cross-sectional view, respectively, of example battery cell generated using the process illustrated in FIGS. 10-10E in accordance with one or more implementations.

FIGS. 11C and 11D illustrate a perspective view and a cross-sectional view, respectively, of an example battery cell having two electrode stacks disposed on opposing sides of a central support structure of a structural member of a battery cell in accordance with one or more implementations.

FIG. 12 illustrates a perspective view of components of a battery cell in accordance with one or more implementations.

FIG. 13 illustrates an exploded perspective view of housing structures for the battery cell of FIG. 12 in accordance with one or more implementations.

FIG. 14 illustrates a battery cell having a structural member, in various stages of swelling of the battery cell in accordance with one or more implementations.

FIG. 15 illustrates a thermal flow for a battery cell having a structural member in accordance with one or more implementations.

FIG. 16 illustrates a battery cell having a structural member with flow channels therein in accordance with one or more implementations.

FIG. 17 illustrates a top view of a battery pack having multiple battery cells, each having a structural member, in accordance with one or more implementations.

FIG. 18 illustrates a flow chart of illustrative operations that may be performed for assembling a battery cell in accordance with one or more implementations.

FIG. 19 illustrates a perspective view of an example of a battery cell, in accordance with one or more implementations of the present disclosure.

FIG. 20 illustrates an exploded view of a battery cell, in accordance with one or more implementations of the present disclosure.

FIG. 21 illustrates a side view of a housing, in accordance with one or more implementations of the present disclosure.

FIG. 22 illustrates a side view of a battery, showing electrode layers within a housing of the battery, in accordance with one or more implementations of the present disclosure.

FIG. 23 illustrates a perspective view of multiple battery cells stacked together, in accordance with one or more implementations of the present disclosure.

FIG. 24 illustrates a perspective view of multiple battery cells in a staggered configuration, in accordance with one or more implementations of the present disclosure.

FIG. 25 illustrates a plan view of multiple batteries and a cooling structure, in accordance with one or more implementations of the present disclosure.

FIG. 26 illustrates a flow diagram showing an example of a process that may be performed for forming a battery cell, in accordance with one or more implementations of the present disclosure.

FIG. 27 illustrates a flow diagram showing an alternate example of a process that may be performed for forming a battery cell, in accordance with one or more implementations of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to a structural member for battery cell. A structural member as described herein may help to (i) form a structural cell that acts as a load-bearing member in a battery pack, and provides stiffness and/or energy-absorption during normal vehicle operation and/or external load or impact events, (ii) provide improved thermal management for the battery cell, (iii) maintain structural integrity in the presence of cell swelling, and/or (iv) facilitate a compact arrangement with double the voltage by, for example, providing a hermetically-sealed cell on each side of a central support structure of an I-beam. Battery cells described herein may include prismatic battery cells, as a non-limiting example. In one or more implementations, the housing may include a contoured housing with multiple curved surfaces. For example, a contoured housing described herein may include opposing ends, each having a radius of curvature that forms a semi-circle. The opposing ends may be separated from each other by planar portions of the housing. Moreover, when a battery cell is formed in part by winding one or more electrode layers, a contoured housing with curved surfaces more closely conforms to the shape of the wound electrode layer(s). As a result, when the electrode layer(s) is/are inserted into the contoured housing, the amount of free space between the electrode layer(s) and the contoured housing reduces, as compared to the amount of free space using a square or rectangular housing. By reducing the free space, the electrode layer(s) wetting rate (e.g., the rate at which an electrolyte may diffuse into the electrode layer(s)) may increase, leading to lower wetting times of the electrode layer(s). Beneficially, the overall performance of the battery cell may increase. Additional benefits of using a contoured housing over a square/rectangular housing include higher structural loading (e.g., less buckling), wider tolerances, and flexible cooling strategies.

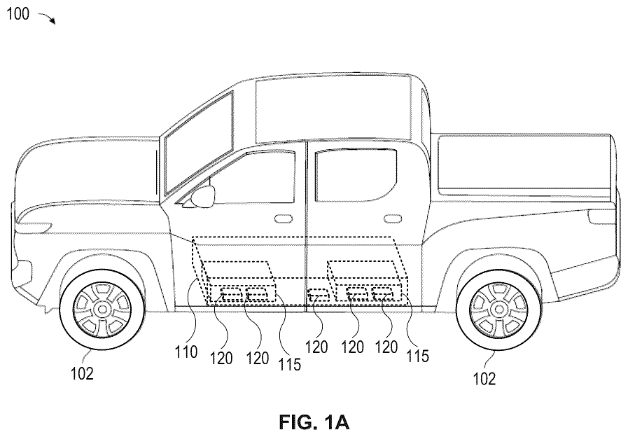

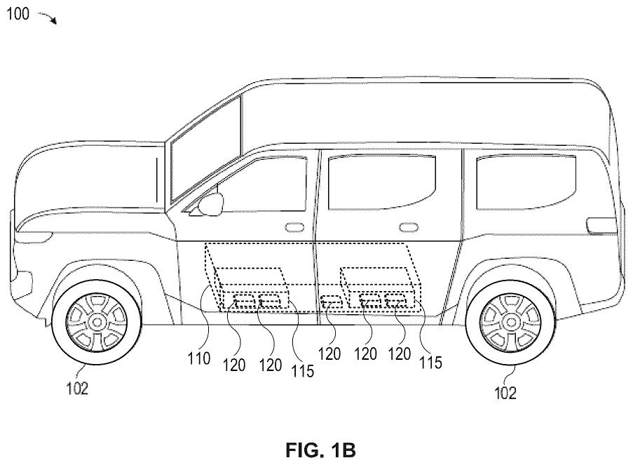

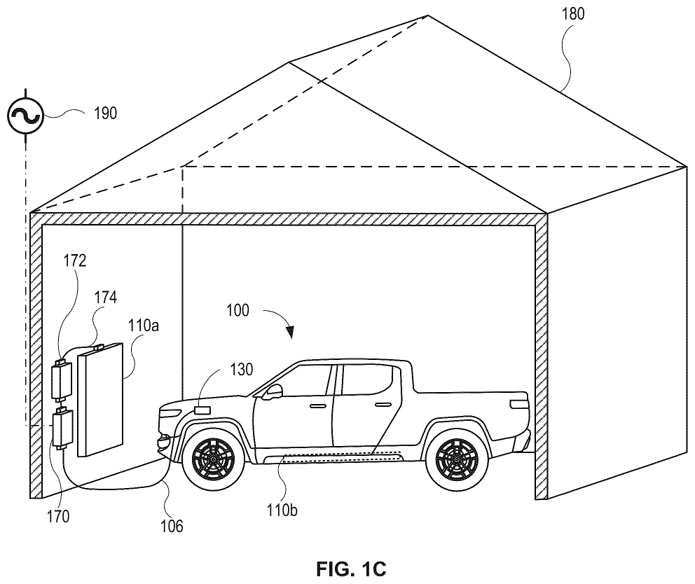

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

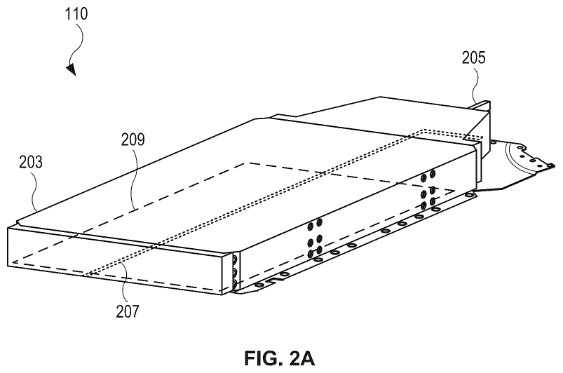

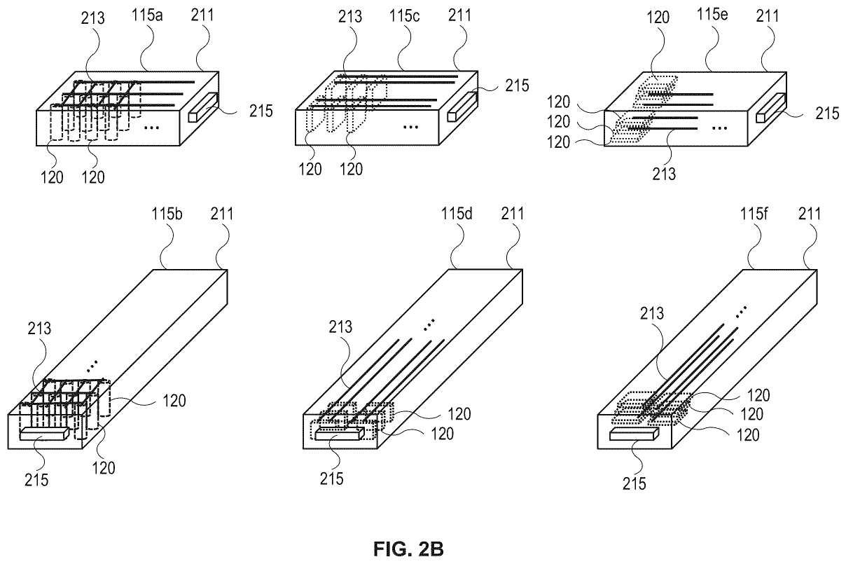

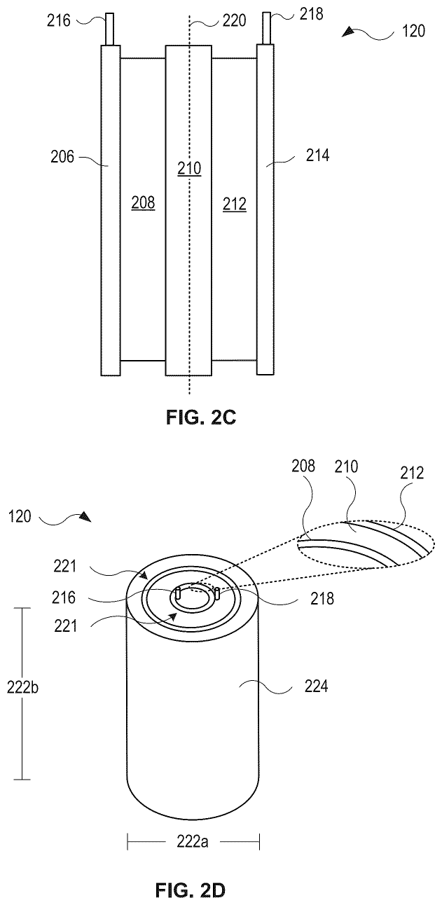

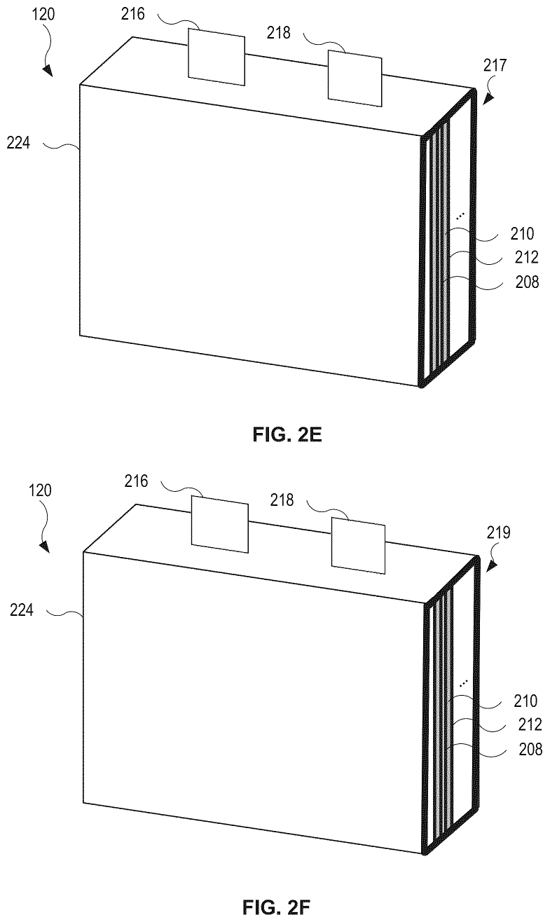

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208 (representative of one or more anode layers), an electrolyte 210 (representative of one or more electrolyte layers), and a cathode 212 (representative of one or more cathode layers). As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

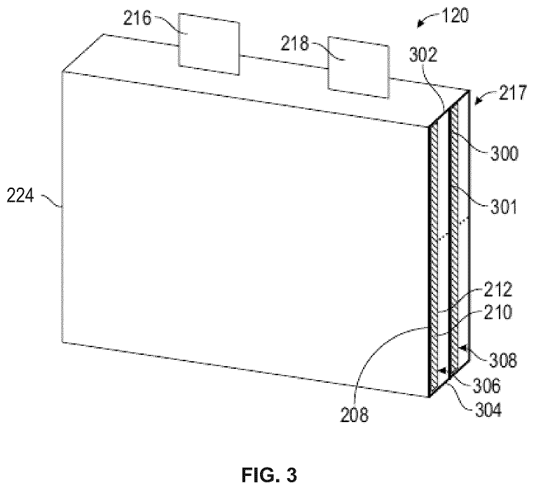

In one or more implementations in which the battery cell 120 is implemented as a prismatic battery cell, as in the example of FIG. 2E, the battery cell 120 may be provided with an structural member, such as an I-beam. For example, FIG. 3 illustrates a cross-sectional perspective view of the battery cell 120 in a prismatic form and that includes a structural member 300.

As shown, the structural member 300 of the battery cell 120 may include a central support structure 301 that extends through a middle of the battery cell 120. As shown, one or more layers, each including an anode 208, cathode 212, and electrolyte 210 (e.g., a stack of multiple sets of anode layers, cathode layers, and electrolyte layers) may be disposed on each side of the central support structure 301 within the cell housing 224.

As shown, the structural member 300 may include a first flange 302 at a first end of the central support structure 301 and a second flange 304 at a second end of the central support structure 301 (e.g., such that the central support structure 301, the first flange 302, and the second flange 304 form an I-beam). As shown, the structural member 300 may be configured to receive an electrode stack 306 (e.g., including one or more anode layers, one or more cathode layers, and one or more electrolyte layers) on a first side of the central support structure 301, and an electrode stack 308 (e.g., each including one or more anode layers, one or more cathode layers, and one or more electrolyte layers) on an opposing second side of the central support structure 301.

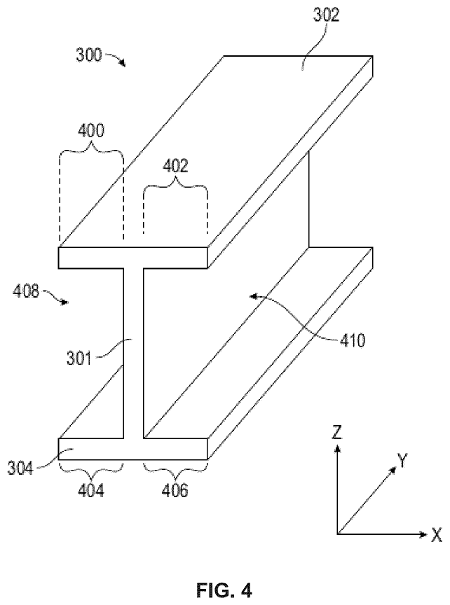

FIG. 4 illustrates a perspective view of the structural member 300 in accordance with one or more implementations. As shown in FIG. 4, the structural member 300 may define a cavity 408 defined, in part, by the central support structure 301, a first portion 400 of the first flange 302 and a first portion 404 of the second flange 304. For example, the cavity 408 may be formed between the first portion 400 of the first flange 302 and the first portion 404 of the second flange 304. As shown in FIG. 4, the structural member 300 may also define a cavity 410 formed, in part, by the central support structure 301, a second portion 402 of the first flange 302 and a second portion 406 of the second flange 304. For example, the cavity 408 may be formed between the second portion 402 of the first flange 302 and the second portion 406 of the second flange 304. As shown in FIG. 4, the structural member 300 may be implemented as an I-beam that is formed from a rigid material, such as aluminum or steel.

Providing a structural member 300 in a battery cell, such as battery cell 120 may provide structural battery cell with enhanced strength (e.g., resistance to compression and/or deformation) with respect to external forces. For example, the central support structure 301 may provide an enhanced strength for a battery cell in a dimension along the length of the central support structure (e.g., along a direction parallel to the y-direction of FIG. 4), and an enhanced strength for a battery cell in a dimension along the height of the central support structure (e.g., along a direction parallel to the z-direction of FIG. 4). The first flange 302 and the second flange 304 may provide an enhanced resistance to bending or twisting of a battery cell (e.g., in an angular direction around the z-axis of FIG. 4). In this way, a battery cell implementing the structural member 300 may be a structural battery cell that can be used as a structural element of a larger structure, such as for stacking of and/or onto the structural battery cells, and/or for managing and/or distributing external forces away from impact sensitive components (e.g., the electrode stacks) of the battery cell and/or other structures.

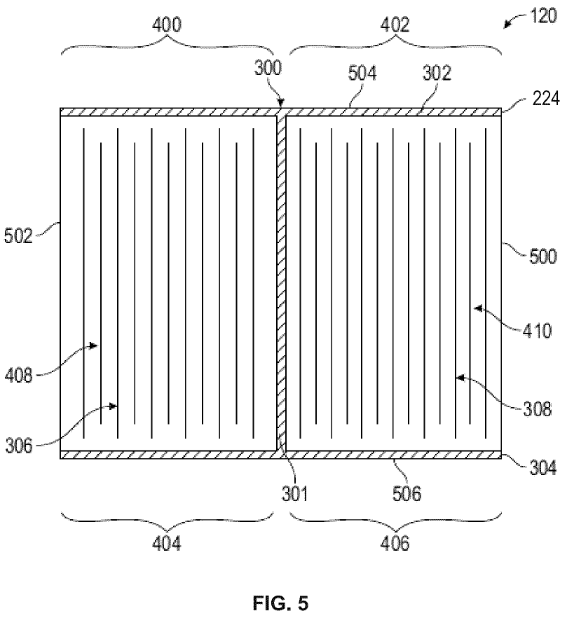

As shown in the cross-sectional view of FIG. 5, the structural member 300 may be configured to receive the electrode stack 306 within the cavity 408 formed, in part, by the central support structure 301, the first portion 400 of the first flange 302, and the first portion 404 of the second flange 304. As shown, the structural member 300 may be configured to receive an electrode stack 308 within the cavity 410 formed, in part, by the central support structure 301, the second portion 402 of the first flange 302, and the second portion 406 of the second flange 304. As illustrated by FIG. 5, the first flange 302 may be configured to form a first surface 504 (e.g., a top surface) of a cell housing 224 for the battery cell 120, and the second flange 304 may be configured to form a second surface 506 (e.g., a bottom surface) of the cell housing 224 for the battery cell 120.

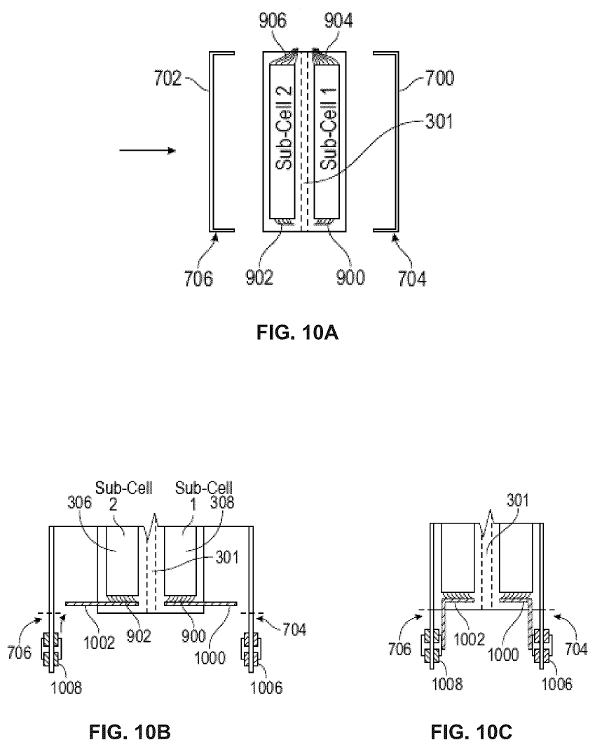

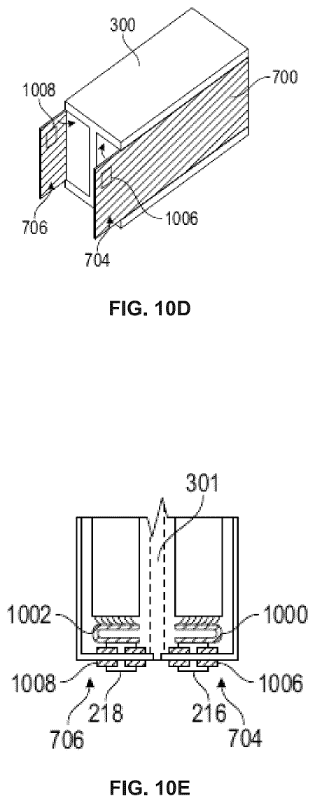

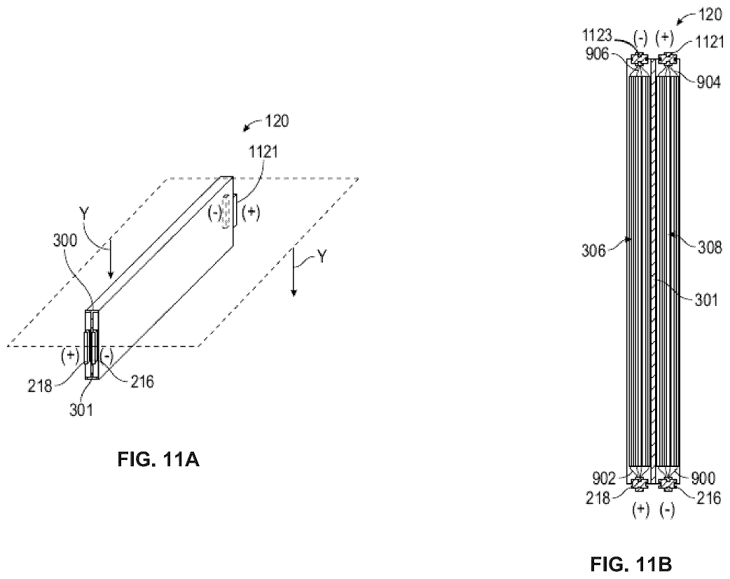

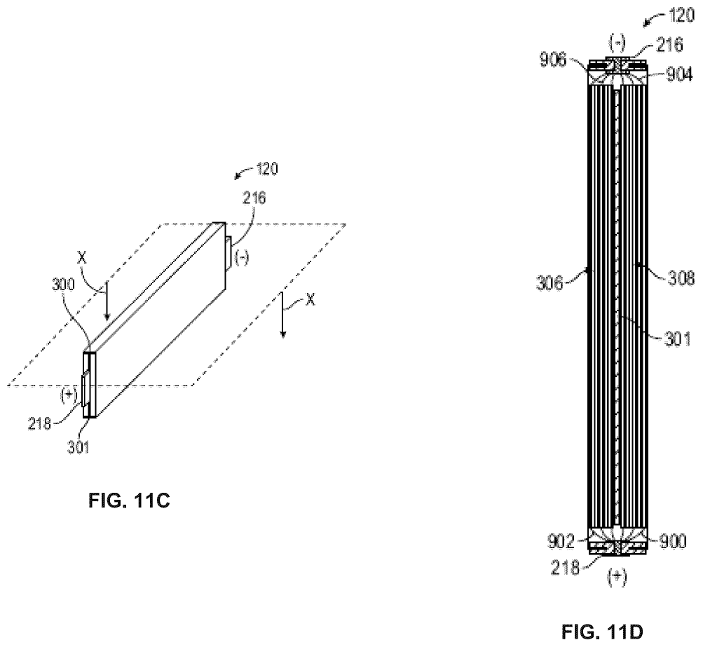

In one or more implementations, a battery cell 120 implementing a structural member 300 may also include one or more housing structures attached to the structural member. The housing structure(s) may form at least a third surface 500 and/or a fourth surface 502 of the cell housing 224. In one or more implementations, once encapsulated by the flanges of the structural member 300 and the housing structures, an electrolyte (e.g., electrolyte 210) may be provided within the cavity 408 and the cavity 410. For example, the electrolyte may be provided between the electrodes of the electrode stack 306 and the electrode stack 308, and may be fluidly communicable between the cavity 408 and the cavity 410. As discussed in further detail hereinafter in connection with, for example, FIGS. 10A-11, in one or more other implementations, the electrode stack 306 and the electrode stack 308 may be encapsulated separately (e.g., hermetically sealed) with electrolyte within each sealed stack to form two individual cells that can be placed into the cavities 408 and 410, respectively. In these other implementations, the separate individual cells in the cavities 408 and 410 may be coupled in series to provide double the voltage. In these other implementations, the battery cell 120 may be a supercell, or other battery unit, including two sub-cells.

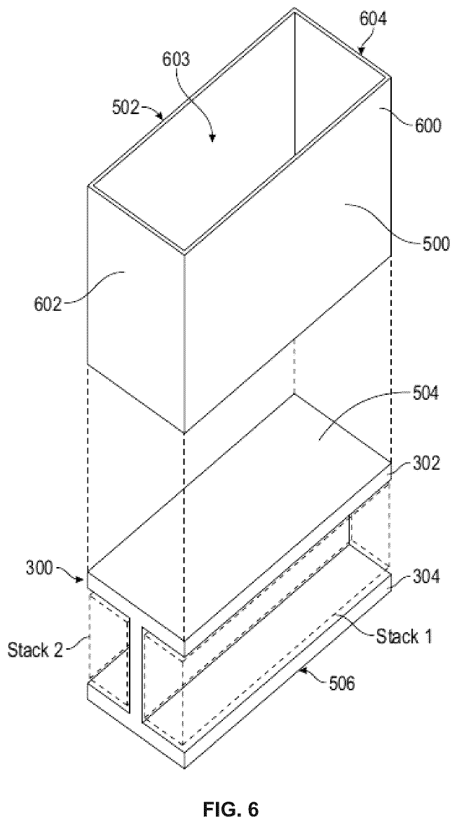

FIG. 6 illustrates an implementation in which a housing structure 600 is provided in the shape of a rectangular prism having an opening 603. As shown in FIG. 6, the opening 603 is configured to slide over the structural member 300, such that the housing structure 600 forms the third surface 500, the fourth surface 502, a fifth surface 602, and a sixth surface 604. In this example, the first flange 302 of the structural member 300 forms the first surface 504 of the cell housing 224, the second flange 304 forms the second surface 506 of the cell housing 224, and the housing structure 600 forms all of the remaining surfaces of the cell housing 224.

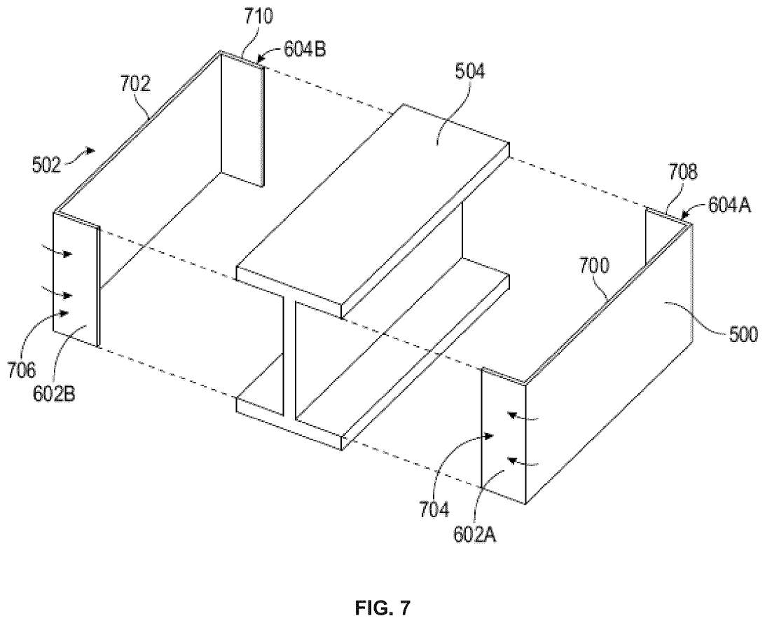

FIG. 7 illustrates another example implementation in which two housing structures combine to form the remaining surfaces of the cell housing 224. In the example of FIG. 7, a first housing structure 700 and a second housing structure 702 are configured to combine to form the remaining surfaces of the cell housing 224. In this example, the first housing structure 700 and the second housing structure 702 may be a pair of c-shaped shell structures configured to be welded to the structural member 300 and/or to each other to enclose the cavities 408 and 410 (e.g., and the electrode stack(s) therewithin). In this example, the first housing structure 700 includes a first end portion 704 that forms a first part 602A of the fifth surface 602, and an opposing second end portion 708 that forms a first part 604A of the sixth surface 604 when the first housing structure 700 is attached (e.g., welded) to the structural member 300. In this example, the second housing structure 702 includes a first end portion 706 that forms a second part 602B of the fifth surface 602 and an opposing second end portion 710 that forms a second part 604B of the sixth surface 604 when the second housing structure 702 is attached (e.g., welded) to the structural member 300.

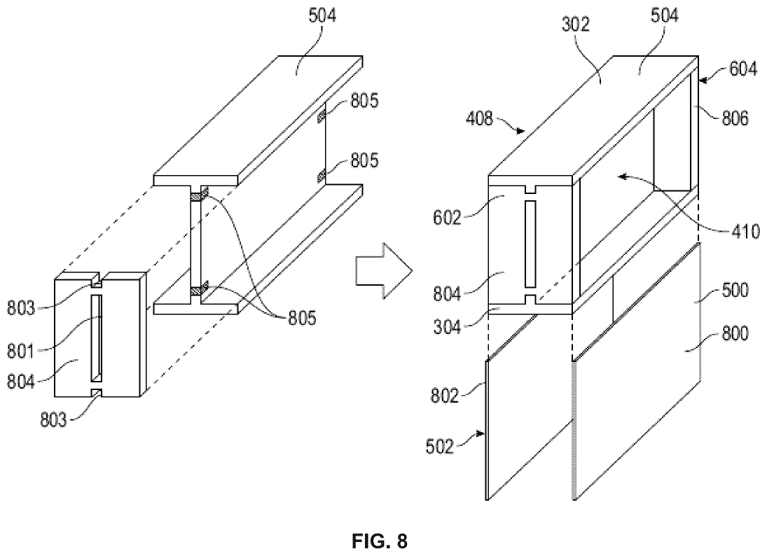

FIG. 8 illustrates another example implementation in which multiple housing structures combine to form the remaining surfaces of the cell housing 224. In the example of FIG. 8, the housing structures that attach to the structural member 300 to form the cell housing 224 include a first flexible membrane 800 and a second flexible membrane 802. As illustrated in FIG. 8, the first flexible membrane 800 may be attached to the first flange 302 and the second flange 304 to form the third surface 500 of the cell housing 224. In this example, the second flexible membrane 802 may be attached to the first flange 302 and the second flange 304 to form the fourth surface 502 of the cell housing 224.

In this example, the housing structures that attach to the structural member 300 to form the cell housing 224 also include a first end piece 804 and a second end piece 806. As shown, the first end piece 804 may be configured to attach to a first end of the structural member 300, and the second end piece 806 may be configured to attach to a second end of the structural member 300. For example, the first end piece 804 and the second end piece 806 may each include one or more notches 803 and/or a central opening 801. For example, the notches 803 and/or the central opening 801 may be configured to receive one or more corresponding extensions on an end of the structural member 300. For example, each of the ends of the structural member 300 may include a pair of notches 805 that receive a portion of an end piece between a notch 803 and the central opening 801 thereon. The notches 805 may be formed between the central opening 801and the extensions on the ends of the structural member 300 that are received in the notches 803.

As illustrated in FIG. 8, the first flexible membrane 800 may attach (e.g., at opposing ends thereof) to a first end of the first end piece 804 and a first end of the second end piece 806, in addition to attaching to the first flange 302 and the second flange 304, to seal the cavity 410. The second flexible membrane 802 may attach (e.g., at opposing ends thereof) to a second end of the first end piece 804 and a second end of the second end piece 806, in addition to attaching to the first flange 302 and the second flange 304, to seal the cavity 408. As shown, the first end piece 804 may form the fifth surface 602 of the cell housing, and the second end piece 806 may form the sixth surface 604 of the cell housing 224.

As discussed in further detail hereinafter, providing a cell housing 224 a structural member 300 and with flexible membranes (e.g., the first flexible membrane 800 and the second flexible membrane 802) may allow expansion of the battery cell 120 during the life of the battery cell 120, without compromising the strength of the battery cell. In this way, the battery cell 120 may be provided with hybrid benefits of prismatic and pouch cells.

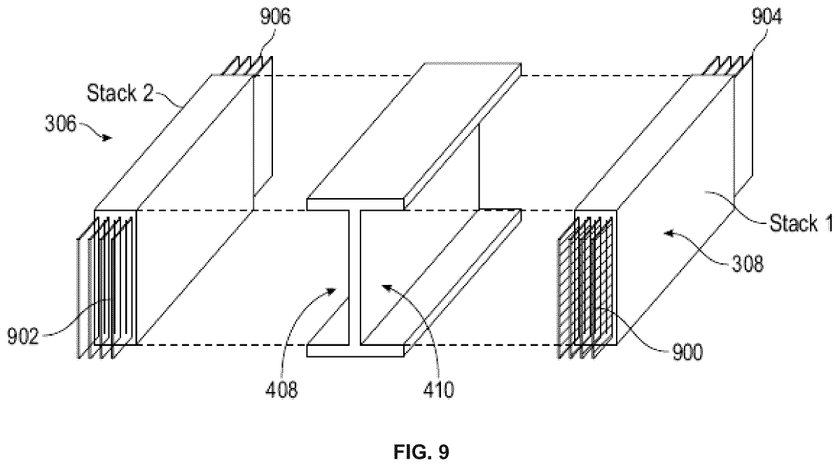

As shown in FIG. 9, the electrode stack 306 may be inserted into the cavity 408 on the first side of the central support structure 301, and the electrode stack 308 may be inserted into the cavity 410 on the second side of the central support structure 301. As shown, each of the electrode stacks 306 and 308 may include one or more tabs (e.g., foil tabs) that extend from the ends of the respective electrode stacks to allow connection of the electrodes in the electrode stacks to one or more terminals of a battery cell. In the example of FIG. 9, the electrode stack 306 includes tabs 902 (e.g., extending from positive electrodes of the electrode stack) at a first end thereof, and tabs 906 (e.g., extending from negative electrodes of the electrode stack) at a second end thereof. In this example, the electrode stack 308 includes tabs 900 (e.g., extending from positive electrodes of the electrode stack) at a first end thereof and tabs 904 (e.g., extending from negative electrodes of the electrode stack) at a second end thereof.

In various implementations, the tabs 900 of the electrode stack 308 may be electrically coupled to the tabs 902 of the electrode stack 306, or the tabs 900 of the electrode stack 308 and the tabs 902 of the electrode stack 306 may be separately electrically one or more first terminals (e.g., positive terminals) on the cell housing 224 (e.g., on a first end of the cell housing). In various implementations, the tabs 904 of the electrode stack 308 may be electrically coupled to the tabs 906 of the electrode stack 306, or the tabs 904 of the electrode stack 308 and the tabs 906 of the electrode stack 306 may be separately electrically coupled to one or more second terminals (e.g., negative terminals) on the cell housing 224 (e.g., on an opposing second end of the cell housing).

As discussed herein, in an alternative implementation, the electrode stacks 306 and 308 may each be hermetically sealed with electrolyte therewithin, and the resulting sub-cells can be provided into the cavities 408 and 410 respectively. In these alternative implementations, the polarity of the tabs discussed in connection with FIG. 9 can be reversed (e.g., so that the sub-cells can be coupled in series, to double the voltage provided by the battery cell 120). For example, FIGS. 10A-10E illustrate various stages of an exemplary process for assembling the battery cell 120 as a battery cell unit having a structural member 300 and two individual, hermetically sealed sub-cells. For example, FIG. 10A illustrates a top-down view of the battery cell of FIG. 9 (e.g., with the first flange 302 omitted for clarity) in an implementation in which a sub-cell (e.g., sub-cell 2) formed from the electrode stack 306 includes tabs 902 extending from positive electrodes of the electrode stack 306 and tabs 906 extending from negative electrodes of the electrode stack 306, and a sub-cell (e.g., sub-cell 1) formed from the electrode stack 308 includes tabs 900 extending from negative electrodes of the electrode stack and tabs 904 extending from positive electrodes of the electrode stack 308.

As shown, after providing the sub-cell formed from the electrode stack 306 into the cavity 408 and the sub-cell formed from the electrode stack 308 into the cavity 410, the tabs 902 may be folded into contact with each other, and the tabs 900 may be folded into contact with each other. In this example, the tabs 904 and the tabs 906 may be gathered and electrically coupled (e.g., welded) to each other and/or to the central support structure 301 and/or another portion of the structural member 300. In this way, the sub-cells formed from the electrode stack 306 and the electrode stack 308 may be electrically coupled together (e.g., in series), such as via the structural member 300. In this example, the structural member 300 is configured to electrically couple the electrode stack 306 to the electrode stack 308 (e.g., the structural member 300 may act as a busbar for the electrode stack 306 and the electrode stack 308). In one or more implementations, the structural member 300 may allow the electrode stack 306 and the electrode stack 308 to each be the same (or similar) size as a single electrode stack of a common (e.g., 3.2V) prismatic battery cell without a structural member 300, and may thus allow the battery cell 120 to provide double the voltage (e.g., 6.4V) that a common prismatic battery cell without a structural member 300 typically provides (e.g., while preventing the electrolyte within each sub-cell from being exposed to voltages higher than, for example, 3.2 volts or 4 volts).

As shown in FIG. 10A, in one or more implementations, housing structures, such as the first housing structure 700 and the second housing structure 702 of FIG. 7 (e.g., c-shell structures) may then be moved into position to enclose the sub-cell (e.g., sub-cell 2) including the electrode stack 306 in the cavity 408 and the sub-cell (e.g., sub-cell 1) including the electrode stack 308 in the cavity 410.

FIG. 10B illustrates how the end portions 704 and 706 of the first housing structure 700 and the second housing structure 702 may be bent open (e.g., into a substantially straight alignment with the planar portion of the respective housing structure), and a first connector 1006 (e.g., a feedthrough connector, such as a glass to metal feedthrough, that is insulated from the first housing structure 700 as a conductor passes through to expose a terminal, such as the terminal 216, outside the first housing structure 700) may be mounted to the end portion 704, and a second connector 1008 (e.g., a feedthrough connector, such as a glass to metal feedthrough, that is insulated from the second housing structure 702 as a conductor passes through to expose a terminal, such as the terminal 218, outside the second housing structure 702) may be mounted to the end portion 706. As shown, a current collector 1000 may be attached (e.g., welded) to the tabs 900, and a current collector 1002 may be attached (e.g., welded) to the tabs 902.

FIG. 10C illustrates how the current collector 1000 may be bent into contact with the first connector 1006 (e.g., and electrically coupled, such as by welding, thereto), and the current collector 1002 may be bent into contact with the second connector 1008 (e.g., and electrically coupled, such as by welding, thereto). FIG. 10D illustrates a perspective view of the battery cell in the configuration of 10C, with the end portions 704 and 706 in an open configuration with the first connector 1006 and the second connector 1008 mounted thereto (with the electrode stacks and current collectors omitted for clarity). As shown in FIG. 10E, end portions 704 and 706 may then be bent into a closed configuration (e.g., and welded to the central support structure 301) to complete the cell housing with the terminals 216 and 218.

FIG. 11A illustrates a perspective view of a battery cell 120 formed from the process described above in connection with FIGS. 10A-10E. For example, in the perspective view of FIG. 11A, the terminals 216 and 218 shown in FIG. 10E can be seen at a first end of the battery cell 120, and an additional positive terminal 1121 can be seen at an opposing second end of the battery cell 120. FIG. 11B illustrates a cross-sectional top view of the battery cell 120, with the cross-section taken along plane Y-Y of FIG. 11A. In the example of FIG. 11B, an additional negative terminal 1123 can be seen at the opposing second end of the battery cell 120. FIG. 11B also shows how, in addition to the arrangement of the tabs 900 and 902 described in connection with FIG. 10E, the tabs 906 (e.g., extending from negative electrodes of the hermetically sealed electrode stack 306 in this example) may be in electrical contact with the additional negative terminal 1123, and the tabs 904 (e.g., extending from positive electrodes of the hermetically sealed electrode stack 308 in this example) may be in electrical contact with the additional positive terminal 1121. However, the arrangement of battery cell 120 shown in FIGS. 11A and 11B is merely illustrative of the alternative implementation in which the electrode stacks are hermetically sealed and the two resulting sub-cells are provided with the structural member 300 to provide a battery cell unit with double the voltage.

FIG. 11C illustrates a perspective view of a battery cell 120 in an implementation in which the electrode stack 306 and the electrode stack 308 on opposing sides of the central support member 301 are disposed within a fluidly coupled space within the battery cell 120. As shown, in the perspective view of FIG. 11C, the terminals 216 and 218 are provided on opposing ends of the battery cell 120. FIG. 11D illustrates a cross-sectional top view of the battery cell 120, with the cross-section taken along plane X-X of FIG. 11C. In the example of FIG. 11D, the tabs 906 (e.g., extending from negative electrodes of the electrode stack 306 in this example) and the tabs 904 (e.g., extending from negative electrodes of the electrode stack 308 in this example) may be in electrical contact with the terminal 216 (e.g., a single terminal at one end of the battery cell 120), and the tabs 902 (e.g., extending from positive electrodes of the electrode stack 306 in this example) and the tabs 900 (e.g., extending from positive electrodes of the electrode stack 308 in this example) may be in electrical contact with the terminal 218 (e.g., a single terminal at the other end of the battery cell 120).

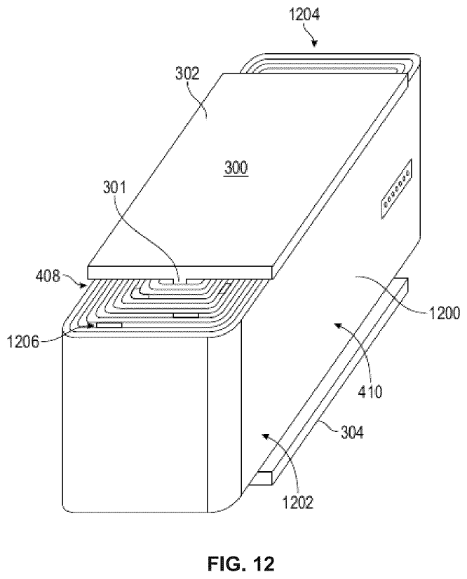

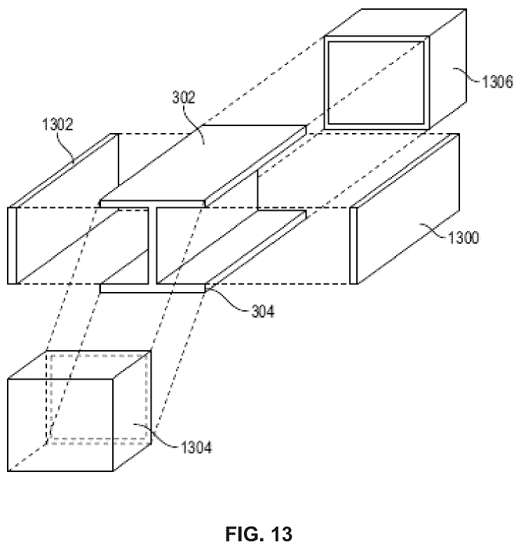

In the examples of FIGS. 9-11D, the electrode stack 306 and the electrode stack 308 are two separate electrode stacks (e.g., which may be coupled together, such as via the structural member 300). In one or more other implementations, the electrode stack 306 and the electrode stack 308 may be two portions of a single rolled electrode stack. For example, FIG. 12 illustrates an implementation of the battery cell 120 in which the central support structure 301 of the structural member 300 is configured to support a rolled stack of electrodes 1200 that wraps around the central support structure 301. As shown, the rolled stack of electrodes 1200 may form a flattened “jelly roll” that includes a portion (e.g., corresponding to the electrode stack 306) that is disposed in the cavity 408, a portion (e.g., corresponding to the electrode stack 308) that is disposed in the cavity 410, a portion 1202 that extends beyond the structural member 300 and wraps around a first end of the central support structure 301, and a portion 1204 that extends beyond the structural member 300 and wraps around an opposing second end of the central support structure 301. As shown, one or more tabs 1206 (e.g., foil tabs) may be formed on the portion 1202 (e.g., and/or the portion 1204) for connection between the electrodes of the rolled stack of electrodes 1200 and an external terminal, such as the terminal 216 and/or the terminal 218 as described herein.

FIG. 13 illustrates an example of housing structures that may be used for a battery cell having a rolled stack of electrodes 1200 that wraps around the central support structure 301 (e.g., as in the example of FIG. 12). In this example, the cell housing 224 of the battery cell 120 may be formed from the first flange 302, the second flange 304, a first planar member 1300 that attaches (e.g., via one or more welds) to the first flange 302 and the second flange 304 on a first side of the structural member 300, a second planar member 1302 that attaches (e.g., via one or more welds) to the first flange 302 and the second flange 304 on a second side of the structural member 300, a first end cap 1304, and a second end cap 1306. As illustrated in FIG. 13, the first end cap 1304 may include a cavity configured to enclose the portion 1202 of the rolled stack of electrodes 1200, and the second end cap 1306 may include a cavity configured to enclose the portion 1204 of the rolled stack of electrodes 1200. The first end cap 1304 may be attached (e.g., welded) to the first flange 302, the second flange 304, the first planar member 1300, and the second planar member 1302 at a first end, and second end cap 1306 may be attached (e.g., welded) to the first flange 302, the second flange 304, the first planar member 1300, and the second planar member 1302 at a second end.

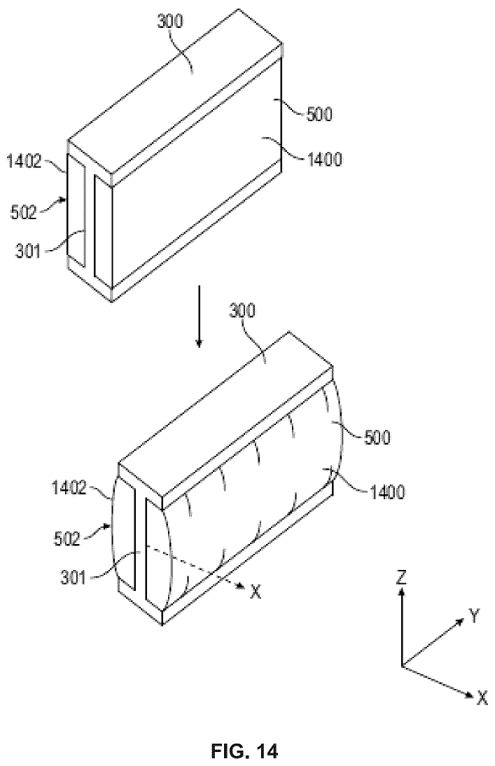

As discussed herein, providing a battery cell with a structural member 300 as described herein can have various benefits, including structural and thermal benefits. For example, FIG. 14 illustrates how a battery cell 120 may be provided with a structural member 300, a housing structure 1400 that forms a first planar surface (e.g., third surface 500) of a cell housing 224, and a housing structure 1402 that forms a second planar surface (e.g., fourth surface 502) of the cell housing 224. As examples, the housing structure 1400 and the housing structure 1402 may be, or may be portions of any of the housing structures described herein in connection with any of FIGS. 5, 6, 7, 8, and/or 13 (e.g., the housing structure 600, the first housing structure 700 and the second housing structure 702, the first flexible membrane 800 and the second flexible membrane 802, or the first planar member 1300 and the second planar member 1302). As illustrated, over time, swelling of the electrode stack(s) within the battery cell 120 may occur, which can generate an outward pressure on the housing structure 1400 and the housing structure 1402. As shown, the housing structure 1400 and the housing structure 1402 may bend or otherwise deform outward (e.g., along the x- and negative x-directions respectively) responsive to pressure from the swelling electrode stack(s).

In this example scenario, in the absence of the structural member 300, this bending of the housing structure 1400 and the housing structure 1402 would reduce the bending strength of the cell housing 224 around the x-axis and/or the z-axis of FIG. 14, and would reduce the amount of (e.g., vertical) load the cell housing is able to support along the z-axis. In contrast, and as illustrated in FIG. 14, because the structure member 300 does not deform (e.g., due to the relatively larger rigidity of the structural member 300 relative to the housing structure 1400 and the housing structure 1402, and/or due to substantially equal and opposing swelling forces on the central support structure 301 that effectively cancel to a net force of zero on the central support structure), the battery cell 120 with the structural member 300 maintains its bending strength and load bearing capabilities, even in the presence of electrode stack swelling.

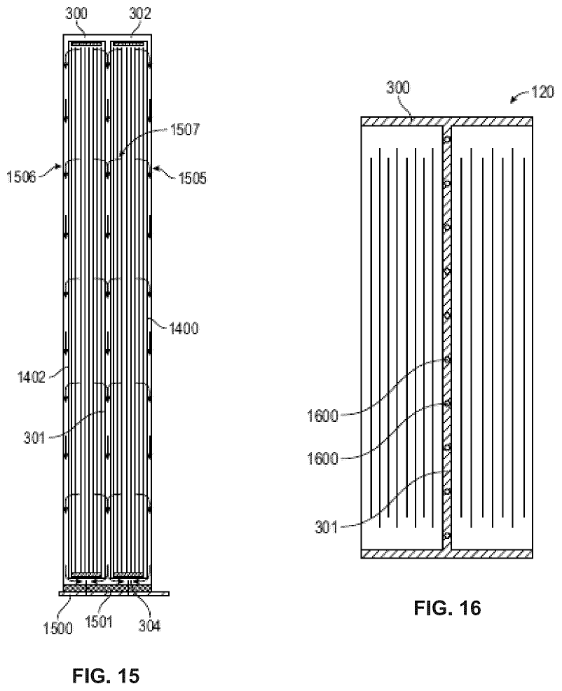

As another example, FIG. 15 illustrates how a battery cell 120 that is provided with a structural member 300 may have improved thermal control features (e.g., relative to a battery cell without a structural member 300). For example, the central support structure 301 may be formed from a thermally conductive material (e.g., aluminum or steel) and may be configured to conduct heat (e.g., generated by the electrode stack 306 and/or the electrode stack 308 during charging and/or discharging of the battery cell) away from the electrode stack 306 and/or the electrode stack 308. For example, as shown in FIG. 15, the battery cell 120 may include a thermal control structure 1500 thermally coupled to the structural member 300. For example, the thermal control structure 1500 may be a cold plate or other thermally conductive structure that is thermally coupled to a cooling fluid and/or a heat sink. In the example of FIG. 15, thermal control structure 1500 is attached to a surface of the second flange 304, such as via a thermal interface material 1501, such as a thermally conductive adhesive.

As shown in FIG. 15, the battery cell having the structural member 300 includes three thermal pathways between the electrode stacks therewithin to the thermal control structure 1500. These include a first thermal pathway 1505 through the housing structure 1400, a second thermal pathway 1506 through the housing structure 1402, and a third thermal pathway 1507 through the central support structure 301. The third thermal pathway 1507 in the middle the battery cell (e.g., relative to a battery cell without third thermal pathway provided by the structural member 300) may reduce the effective thermal resistance of the electrode stacks within the cell housing 224, and can thereby reduce the overall thermal resistance of the battery cell by as much as between thirty and fifty percent (e.g., in comparison with a prismatic battery cell having the same electrode stack(s) and without a structural member 300). In this way, the battery cell 120 having the structural member 300 may be cooled to the same temperature with less cooling fluid and/or pumping of the cooling fluid (e.g., in comparison with cooling a prismatic battery cell having the same electrode stack(s) and without a structural member 300 to the same temperature), or may be cooled to a lower temperature with the same cooling fluid and/or pumping of the cooling fluid (e.g., in comparison with the resulting temperature of a prismatic battery cell having the same electrode stack(s) and without a structural member 300 exposed to the same cooling fluid and/or pumping of the cooling fluid). This may help improve the functioning and/or reliability of the battery cell 120, which can improve the functioning and/or reliability of an vehicle or electric appliance that is powered by the battery cell.

In one or more implementations, the structural member 300 may include one or more fluid pathways configured to receive a thermal control fluid therethrough. For example, FIG. 16 illustrates a cross-sectional view of an example implementation of a battery cell 120 that includes a structural member 300 that includes one or more fluid pathways configured to receive a thermal control fluid therethrough. As shown, in one or more implementations, the central support structure 301 may include one or more fluid channels 1600. A thermal control fluid (e.g., a cooling fluid, or coolant, may be pumped or otherwise passed through the one or more fluid channels 1600 to cool the battery cell (e.g., to a desired temperature). In one or more use cases (e.g., in very cold environments, such as at high altitudes or high latitudes), a warming fluid may be passed through the one or more fluid channels 1600, to warm the battery cell 120 to an improved or optimal operating temperature.

As illustrated by the examples of FIGS. 3-16, in one or more implementations, a battery cell 120 may be provided that includes a structural member 300 that includes a central support structure 301, a first flange 302 at a first end of the central support structure 301, and a second flange 304 at a second end of the central support structure 301, in which the structural member 300 is configured to receive an electrode stack 306 within a cavity 408 formed, in part, by the central support structure 301, a first portion 400 of the first flange 302 and a first portion 404 of the second flange 304. The battery cell 120 may also include the electrode stack 306 disposed at least partially within the cavity 408. The battery cell 120 may also include an electrode stack 308 disposed within an cavity 410 formed, in part, by the central support structure 301, a second portion 402 of the first flange 302 and a second portion 406 of the second flange 304.a

As discussed herein, the structural member 300 of a battery cell 120 may provide various mechanical, structural, and/or thermal advantages, including enhanced bending and/or loading strength for the battery cell 120. A battery assembly, or sub-assembly that includes one or more battery cells 120 having structural members 300 may also be provided with resulting mechanical, structural, and/or thermal advantages. For example, by orienting the structural members 300 of multiple battery cells 120 in a battery assembly, such as a battery module or a battery pack, in a coordinated manner, the battery assembly may be provided with one or more structural advantages, such as improved impact protection for the battery cells.

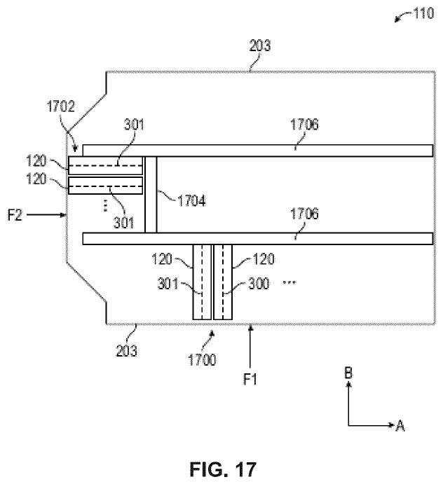

For example, FIG. 17 illustrates an example in which a battery pack 110 includes multiple battery cells 120, each including a structural member 300 that includes a central support structure 301 (shown in dashed lines in FIG. 17). As discussed herein, each structural member of each respective battery cell may also include a first flange 302 at a first end of the central support structure 301, and a second flange 304 at a second end of the central support structure 301, and the structural member may be configured to receive an electrode stack 306 within a cavity 408 formed, in part, by the central support structure 301, a first portion 400 of the first flange 302 and a first portion 404 of the second flange 304 (e.g., and to receive an electrode stack 308 within a cavity 410 formed, in part, by the central support structure, a second portion 402 of the first flange 302 and a second portion 406 of the second flange 304).

As shown, the multiple battery cells 120 may include a first set 1700 of battery cells 120 aligned in a first direction, and a second set 1702 of battery cells 120 aligned in a second direction different from the first direction. For example, the first set 1700 of the battery cells 120 may be aligned in parallel with the “B” direction of FIG. 17 (e.g., such that the central support structure 301 and the central support structure 301 of the battery cells 120 in the first set 1700 have an elongate dimension that extends along a line that is parallel to the “B” direction of FIG. 17). As shown, the second set 1702 of the battery cells 120 may be in parallel with the “A” direction of FIG. 17 (e.g., such that the central support structure 301 and the central support structure 301 of the battery cells 120 in the second set 1702 have an elongate dimension that extends along a line that is parallel to the “A” direction of FIG. 17). As examples, the A direction may be a direction that runs between a front and a rear of a vehicle, such as vehicle 100, and the B direction may be a direction that runs between a left and a right of a vehicle (in one or more implementations). In one or more implementations, the A direction may be orthogonal to the B direction. Although battery cells 120 with structural members 300 aligned along two different directions are shown in FIG. 17, it is appreciated that battery cells 120 with structural members 300 aligned along three or more directions may be arranged in various configurations to provide structural support and/or impact protection for the battery pack 110.

As illustrated in FIG. 17, the structural members 300 (e.g., the central support structure 301, the central support structure 301, the first flange 302 and/or the second flange 304) of the battery cells 120 of the first set 1700 of battery cells 120 may be configured to distribute a force, F1, of an impact to the battery pack 110 (e.g., via an impact to a vehicle in which the battery pack 110 is implemented) along the first direction. The structural members 300 (e.g., the central support structure 301, the central support structure 301, the first flange 302 and/or the second flange 304) of the battery cells 120 of the second set 1702 of battery cells 120 may be configured to distribute a force, F2, of an impact to the battery pack 110 (e.g., via an impact to a vehicle in which the battery pack 110 is implemented) along the second direction. For example, the structural members 300 (e.g., the central support structure 301, the central support structure 301, the first flange 302 and/or the second flange 304) of the battery cells 120 of the first set 1700 of battery cells 120 may be configured to distribute the force, F1, away from and/or around the electrodes of the battery cells 120 to one or more structural features of the battery pack 110 (e.g., to one or more cross-members 1706 of the battery pack). For example, the structural members 300 (e.g., the central support structure 301, the central support structure 301, the first flange 302 and/or the second flange 304) of the battery cells 120 of the second set 1702 of battery cells 120 may be configured to distribute the force, F2, away from and/or around the electrodes of the battery cells 120 to one or more structural features of the battery pack 110 (e.g., to one or more cross-members 1704 of the battery pack). It is also appreciated that, in addition to providing energy-absorption during impact events, providing a battery pack 110 with battery cells 120 having structural members 300 (e.g., as shown in FIG. 17) may also provide energy-absorption and/or structural stability during the normal operation (e.g., acceleration, braking, cornering, etc.) of a vehicle 100 or other movable apparatus in which the battery pack 110 is implemented, by providing stiffness to the battery pack and/or vehicle structure using the variously aligned structural members 300.

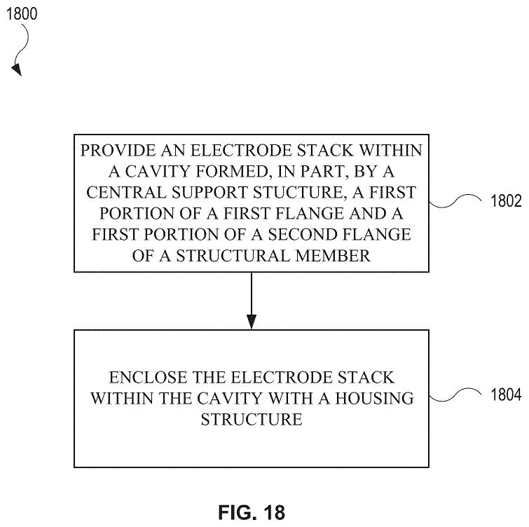

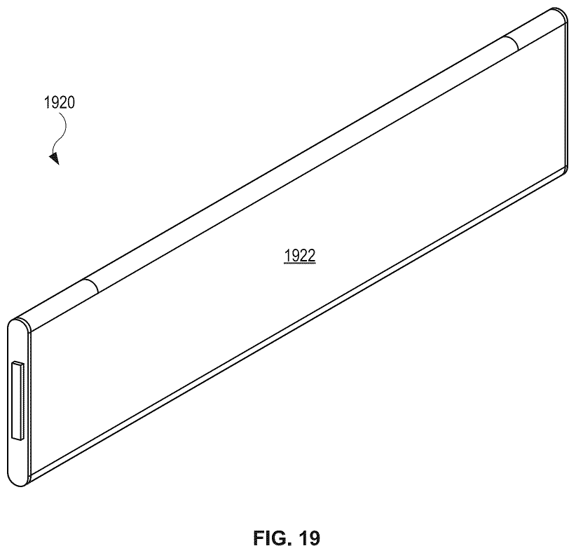

FIG. 18 illustrates a flow diagram of an example process that may be performed for assembling a battery cell, in accordance with implementations of the subject technology. For explanatory purposes, the process 1800 is primarily described herein with reference to the battery cell 120 and the structural member 300 of FIGS. 3-17. However, the process 1800 is not limited to the battery cell 120 and the structural member 300 of FIGS. 3-17, and one or more blocks (or operations) of the process 1800 may be performed by one or more other structural components of other suitable moveable apparatuses, devices, or systems. Further for explanatory purposes, some of the blocks of the process 1800 are described herein as occurring in serial, or linearly. However, multiple blocks of the process 1800 may occur in parallel. In addition, the blocks of the process 1800 need not be performed in the order shown and/or one or more blocks of the process 1800 need not be performed and/or can be replaced by other operations.

As illustrated in FIG. 1800, at block 1802, the process 1800 may include providing an electrode stack (e.g., electrode stack 306) within a cavity (e.g., cavity 408) formed, in part, by a central support structure (e.g., central support structure 301), a first portion (e.g., first portion 400) of a first flange (e.g., first flange 302) and a first portion (e.g., first portion 404) of a second flange (e.g., second flange 304) of a structural member (e.g., structural member 300, such as an I-beam).

At block 1804, the process 1800 may include enclosing the electrode stack within the cavity with a housing structure (e.g., housing structure 600, first housing structure 700, second housing structure 702, first flexible membrane 800, second flexible membrane 802, first planar member 1300, second planar member 1302, housing structure 1400, and/or housing structure 1402).

In one or more implementations, prior to the enclosing, the process 1800 may also include providing an electrode stack 308 within an cavity 410 formed, in part, by the central support structure 301, a second portion 402 of the first flange 302 and a second portion 406 of the second flange 304. The enclosing may include enclosing the additional electrode stack within the additional cavity with the housing structure.

In one or more implementations (e.g., as in the example of FIG. 8), the enclosing may include sealingly attaching a flexible membrane (e.g., first flexible membrane 800 or second flexible membrane 802) to the first flange 302 and the second flange 304. In one or more other implementations (e.g., as in the example of FIG. 6), the enclosing may include providing the structural member with the electrode stack within the cavity into an opening (e.g., opening 603) in a rectangular prismatic housing structure; and welding the rectangular prismatic housing structure to the structural member. In one or more other implementations (e.g., as in the example of FIGS. 7 and/or 10A-10E), the enclosing may include enclosing the structural member with the electrode stack with a c-shaped shell (e.g., first housing structure 700 or second housing structure 702); and welding the c-shaped shell to the structural member. In one or more implementations, the process 1800 may also include welding at least one conductive tab (e.g., one or more of tabs 900, tabs 902, tabs 904, or tabs 906) extending from the electrode stack to at least one of the housing structure or the structural member (e.g., as discussed herein in connection with FIGS. 10A-10E). In one or more implementations, the process 1800 may also include welding at least one conductive tab to a current collector (e.g., as discussed herein in connection with FIGS. 10A-10E).

FIG. 19 illustrates a perspective view of an example of an apparatus 1920, in accordance with one or more implementations of the present disclosure. As a non-limiting example, the apparatus 1920 may take the form of a battery cell, including a prismatic battery cell. In this regard, the apparatus 1920 may include at least some features as those shown and/or described for the battery cell 120 shown in FIG. 2E. The apparatus 1920 may include a housing 1922 designed to enclose one or more electrode layers (not shown in FIG. 19) of the apparatus 1920. In one or more implementations, the housing 1922 includes a metal such as stainless steel. However, other metals and/or rigid materials may be used.

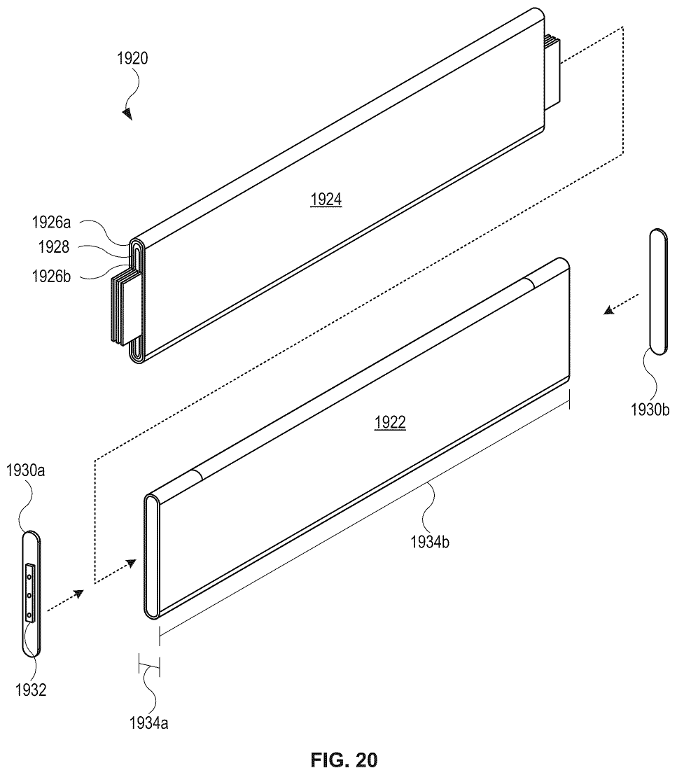

FIG. 20 illustrates an exploded view of the apparatus 1920, in accordance with one or more implementations of the present disclosure. The apparatus 1920 may include one or more electrode layers 1924 that form an electrode stack. The one or more electrode layers 1924 may include a layer of anode material 1926a, a layer of cathode material 1926b, and a separator layer 1928 positioned between the layer of anode material 1926a and the layer of cathode material 1926b. The aforementioned layers of the one or more electrode layers 1924 may be rolled up together to form a wound electrode stack (also referred to as a jelly roll, which may be flattened jelly roll as shown in FIG. 20) and inserted into the housing 1922. In this regard, the one or more electrode layers 1924 may be referred to as one or more wound electrode layers.

The apparatus 1920 may further include a cap 1930a and a cap 1930b. The caps 1930a and 1930b may secure with respective ends of the housing 1922 and enclose the one or more electrode layers 1924 in the housing 1922. Additionally, the cap 1930a may include terminals 1932 one of which is designed to couple (e.g., electrically couple) with the layer of anode material 1926a and another of which is designed to couple with the layer of cathode material 1926b (e.g., via welds to one or more tabs extending from the electrode stack).

Some dimensional features of the apparatus 1920, and in particular the housing 1922, are shown. For example, the housing 1922 may include a dimension 1934a and a dimension 1934b. In one or more implementations, the dimension 1934a is approximately in the range of 20 to 50 mm. Further, in one or more implementations, the dimension 1934b is approximately in the range of 100 to 2000 mm. Based on the dimensional information, the housing 1922 may include a dimension (e.g., dimension 1934b) that is 190 times greater than another dimension (e.g., dimension 1934a). Moreover, based on the dimensional information, the housing 1922 may include a dimension (e.g., dimension 1934b) that is 100 times greater than another dimension (e.g., dimension 1934a).

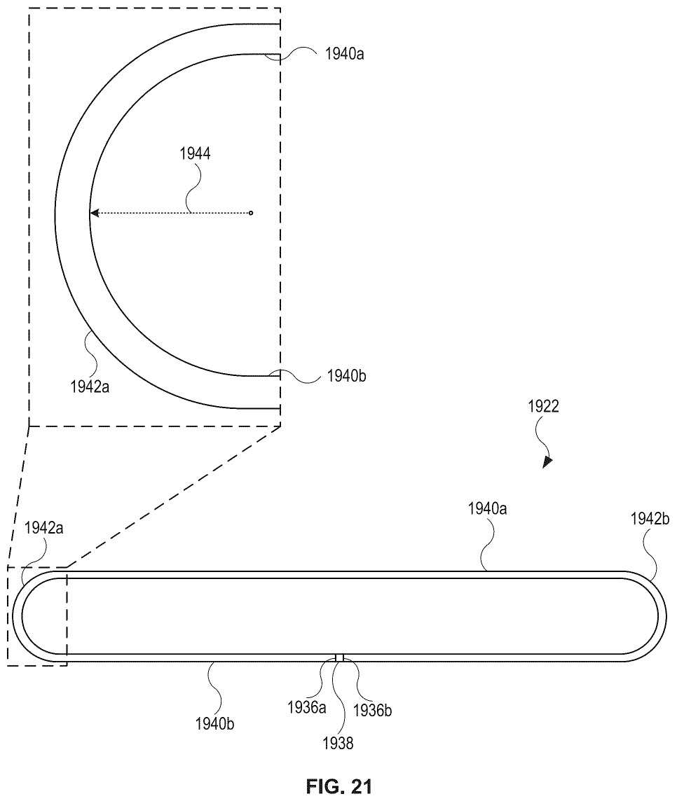

FIG. 21 illustrates a side view of a housing 1922, in accordance with one or more implementations of the present disclosure. The housing 1922 is isolated to show additional features. For example, the housing 1922 may be formed by stamping, or bending, a metal sheet or metal substrate to connect an end 1936a of the metal sheet to an end 1936b of the metal sheet. As a non-limiting example, the ends 1936a and 1936b may be secured together by a weld 1938.

Based on the formation, the housing 1922 may include multiple portions. For example, the housing 1922 may include a planar surface 1940a and a planar surface 1940b. In one or more implementations, the planar surface 1940a is parallel, or at least substantially parallel, with respect to the planar surface 1940b. Further, the housing 1922 may include a curved surface 1942a and a curved surface 1942b. Each of the curved surfaces 1942a and 1942b extends from a portion of the planar surfaces 1940a and 1940b. The curved surfaces 1942a and 1942b may represent round, or otherwise non-planar surfaces. Beneficially, the curved surfaces 1942a and 1942b may allow the housing 1922 to carry an increased load and provide additional resistance to buckling as compared to square or rectangular housings. As shown in the enlarged view, the curved surface 1942a (representative of the curved surface 1942b) may form a radius of curvature having a radius 1944. When the radius 1944 is consistent (e.g., not changing) from the planar surface 1940a to the planar surface 1940b, the curved surface 1942a may form a semi-circle. In this regard, the planar surface 1940a may be separated from the planar surface 1940b by twice the radius 1944. While the curved surface 1942a is characterized as being semi-circular, other shapes are possible. For example, in one or more implementations, the radius 1944 varies. This may allow the housing 1922 to further conform to the shape of the one or more electrode layers 1924 (shown in FIG. 20).

The mass of a semi-circular edged can (e.g., housing 1922) may be approximately in the range of 20% to 30% less than a similarly sized rectangular (traditional) can. In this regard, when several battery cells (e.g., 100 or more battery cells) combine to form a battery pack, battery cells having a semi-circular edge may provide significant mass saving, which may result in an overall lighter weight electric vehicle.

Further, a semi-circular edged can (e.g., housing 1922) may provide an enhanced pressure vessel than a traditional, rectangular can. Battery cells have internal pressure that increases over the life of the battery cell and may reach up to several bars toward the end of life. A semi-circular edged can may better withstand such pressure increases as compared to a traditional, rectangular can. Moreover, a semi-circular edged can may be made thinner, further reducing the mass of the battery cells (with a semi-circular edged can) and hence the battery pack. Beneficially, reducing mass not only would reduce cost, but also improve the vehicle efficiency and hence driving range.

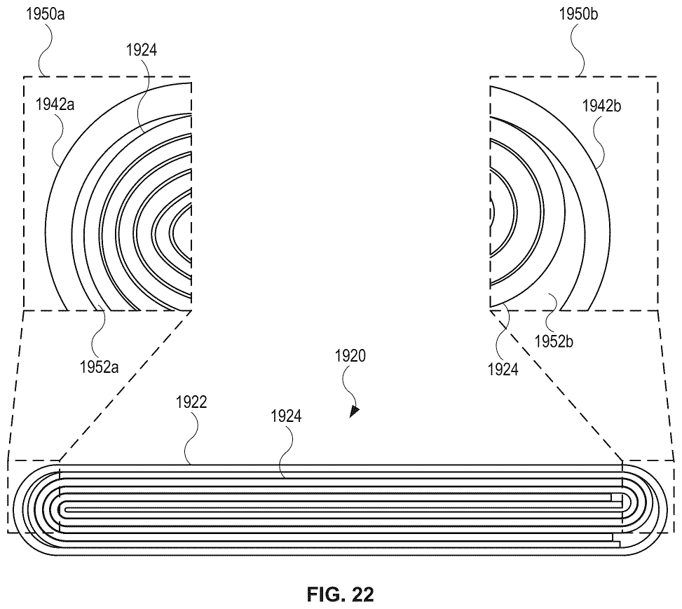

FIG. 22 illustrates a side view of the apparatus 1920, showing the one or more electrode layers 1924 within the housing 1922, in accordance with one or more implementations of the present disclosure. For purposes of illustration, the caps 1930a and 1930b (shown in FIG. 20) are removed. Based on the curved surfaces 1942a and 1942b, the housing 1922 may more closely conform to the shape of the one or more electrode layers 1924 when the one or more electrode layers 1924 are rolled/wound. For example, as shown in an enlarged view 1950a, the curved surface 1942a of the housing 1922 has a curvature that conforms, or at least partially conforms, to the shape of the one or more electrode layers 1924. As a result, a separation 1952a, or gap, between the curved surface 1942a and the one or more electrode layers 1924 may be smaller as compared to square or rectangular housings with 90-degree corners. Similarly, as shown in an enlarged view 1950b, the curved surface 1942b of the housing 1922 has a curvature that conforms, or at least partially conforms, to the shape of the one or more electrode layers 1924, and a separation 1952b between the curved surface 1942b and the one or more electrode layers 1924 may be smaller as compared to square or rectangular housings with 90-degree corners. By reducing the separation (e.g., volume of the separation 1952a and the separation 1952b), the wetting rate of the one or more electrode layers 1924 may increase, thus reducing the wetting time of the one or more electrode layers 1924. For example, because an electrolyte that is introduced into the housing 1922 while the one or more electrode layers 1924 are disposed therein will preferentially flow to open spaces within the housing 1922, a housing have square or rectangular corners may provide larger gaps into which the electrolyte can flow before flowing into the one or more electrode layers 1924. This can not only increase the amount of time to fill the electrode stack with the electrolyte, but can also leave a relatively larger amount of unused electrolyte within a square or rectangular housing, which can be wasteful and can add unnecessary weight to the battery cell and any apparatus within which the battery cell is used. By providing the housing 1922 that is contoured with the curved surfaces 1942a and 1942b, as shown in FIG. 22, the excess space between the housing 1922 and the one or more electrode layers 1924 is reduced, thereby increasing the efficiency with which the electrolyte can be provided into the one or more electrode layers 1924. Beneficially, the increased wetting rate may enhance the efficiency of battery cell production, and/or the reliability and/or performance of the apparatus 1920.

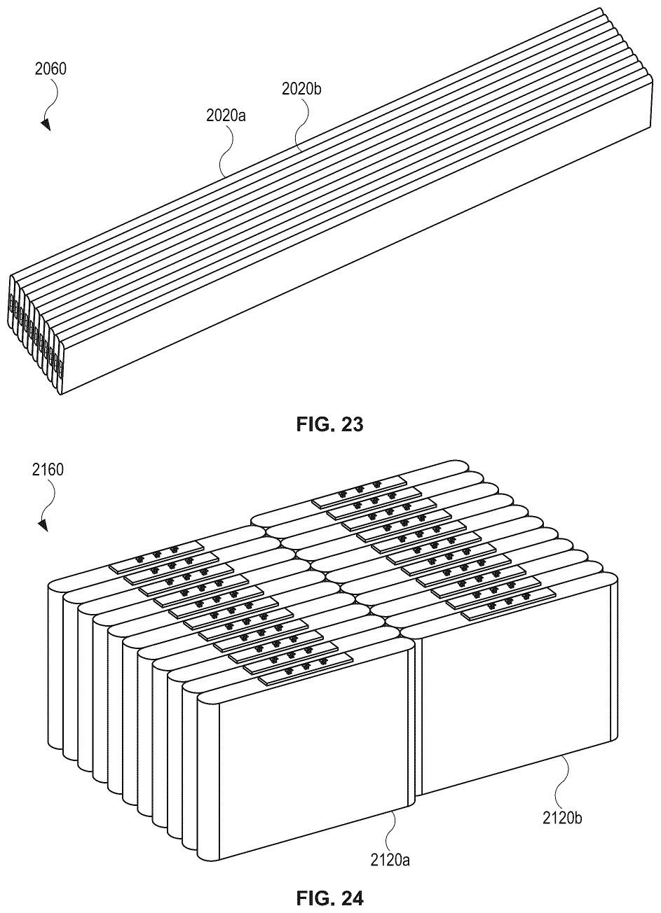

FIG. 23 and FIG. 24 show different manners in which battery cells may be displaced with respect to other battery cells. The battery cells shown and/or described in FIG. 23 and FIG. 24 may include any features shown and/or described herein for a battery cell, including a prismatic battery cell. Also, although a discrete number of battery cells is shown in FIG. 23 and FIG. 24, the number of battery cells may vary.

FIG. 23 illustrates a perspective view of multiple battery cells 2060 stacked together, in accordance with one or more implementations of the present disclosure. When implemented in a battery module, a battery pack, and/or a vehicle (e.g., vehicle 100 shown in FIG. 1A), the multiple battery cells 2060 may be adjacent to and displaced (e.g., laterally displaced) with respect to each other. For example, the multiple battery cells 2060 include a battery cell 2020a and a battery cell 2020b (each representative of additional battery cells) that are adjacent and laterally displaced with respect to each other.

FIG. 24 illustrates a perspective view of multiple battery cells 2160 in a staggered configuration, in accordance with one or more implementations of the present disclosure. When implemented in a battery module, a battery pack, and/or vehicle (e.g., vehicle 100 shown in FIG. 1A), the multiple battery cells 2160 may be adjacent to and staggered (e.g., offset) with respect to each other. For example, the multiple battery cells 2160 include a battery cell 2120a and a battery cell 2120b (each representative of additional battery cells) that are staggered with respect to each other. As shown, the contoured ends of the housings of the multiple battery cells 2160 may allow the staggered battery cells to partially nest with each other, thereby reducing the overall amount of space occupied by the battery cells. This can reduce the size of a battery module and/or battery pack enclosure, and thereby reduce the weight of an electric vehicle, thereby extending the range of the electric vehicle.

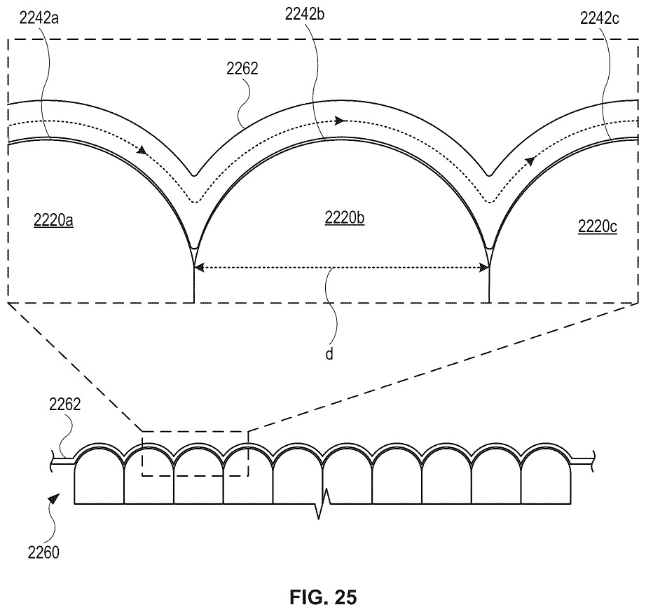

FIG. 25 illustrates a plan view of multiple battery cells 2260 and a cooling structure 2262, in accordance with one or more implementations of the present disclosure. The cooling structure 2262, or cooling tube, may form a part of a thermal/temperature control or heat exchange system to extract thermal energy (e.g., heat) from the multiple battery cells 2260. For example, the cooling structure 2262 may include a hollow body that allows a cooling fluid (represented by dotted lines with arrows) to flow through the cooling structure 2262. As a non-limiting example, the cooling fluid may include a water ethylene glycol solution. Also, the cooling structure 2262 may include a metal (e.g., steel, stainless steel, copper, aluminum) to increase heat transfer by way of the relatively high thermal conductivity of the metal. However, the cooling structure 2262 may be coated with a dielectric material to isolate (e.g., electrically isolate) the cooling structure 2262 from the multiple battery cells 2260.

The cooling structure 2262 may conform, or at least partially conform, to the shape of the multiple battery cells 2260. For example, as shown in the enlarged view, a battery cell 2220a, a battery cell 2220b, and a battery cell 2220c include a curved surface 2242a, a curved surface 2242b, and a curved surface 2242c, respectively, with the curved surfaces 2242a, 2242b, and 2242c representative of additional curved surfaces. The cooling structure 2262 may conform to the shape of each of the curved surfaces 2242a, 2242b, and 2242c. Accordingly, the cooling structure 2262 may remain in contact, or substantially in contact, with battery cells having non-linear surfaces.

Also, the multiple battery cells 2260, having curved surfaces, may provide more flexible cooling opportunities. Based on a curved surface, a battery cell may provide additional surface area for exposure to a cooling structure, thus providing additional capability for extracting heat from the battery cell. For example, a battery cell with a rectangular housing may include a side surface, with a dimension d, which provides a surface for dissipating heat. However, the curved surface 2242b that takes the form of a semi-circular shape may include a surface with a dimension equal to □*d (e.g., approximately 3.14*d). Accordingly, the curved surface 2242b may provide the battery cell 2220 with more than three times the surface area of a rectangular housing. Beneficially, the cooling structure 2262, when conforming to the shape of the curved surface 2242b, may cool the battery cell 2220b (as well as other similar battery cells) at a higher rate. Beneficially, the cooling structure 2262, when conforming to the shape of the curved surface 2242b, may cool the battery cell 2220b (as well as other similar battery cells) at a higher rate.

Although not expressly shown, cooling structures similar to the cooling structure 2262 may include a shape that conforms to multiple battery cells placed adjacent to each other, as shown in FIG. 23 and FIG. 24. Accordingly, cooling structures described herein may be modified and positioned between multiple battery cells either laterally displaced or offset with respect to each other.

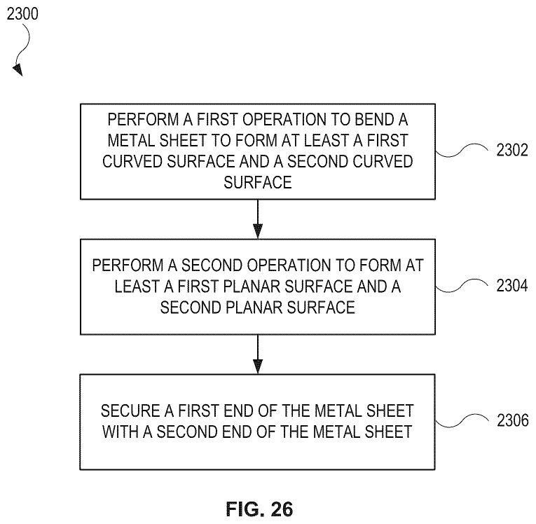

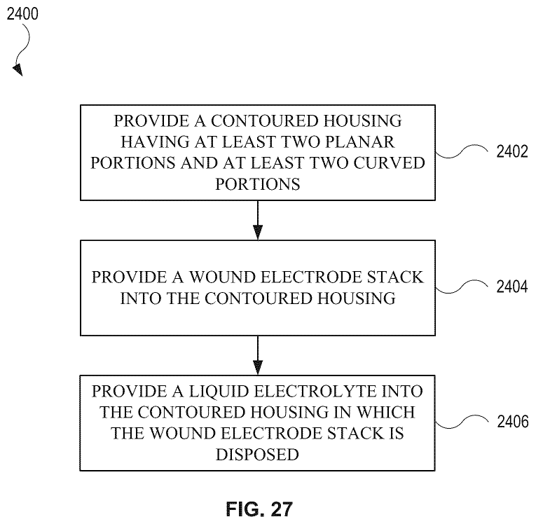

FIG. 26 and FIG. 27 illustrate flow diagrams showing an example processes that may be performed for forming a battery cell, in accordance with implementations of the subject technology. For explanatory purposes, the processes are primarily described herein with reference to the battery cells shown in FIGS. 19-25. However, the processes are not limited to the battery cells in FIGS. 19-25, and one or more blocks (or operations) of the processes may be performed by one or more other components of other suitable moveable apparatuses, devices, or systems. Further for explanatory purposes, some of the blocks of the processes are described herein as occurring in serial, or linearly. However, multiple blocks of the processes may occur in parallel. In addition, the blocks of the processes need not be performed in the order shown and/or one or more blocks of the processes need not be performed and/or can be replaced by other operations.

FIG. 26 illustrates a flow diagram showing an example of a process 2300 that may be performed for forming a battery cell, in accordance with one or more implementations of the present disclosure.

At block 2302, a first operation to bend a metal sheet to form at least a first curved surface and a second curved surface is performed. In one or more implementations, the first curved surface and the second curved surface conform to a shape of a wound battery cell. Further, the curved surfaces may include a semi-circular shape. As non-limiting examples, the first operation may include stamping or extruding the metal sheet. Additionally, the metal sheet may undergo a cutting operation to form one or more openings.

At block 2304, a second operation to form at least a first planar surface and a second planar surface is performed. The first planar surface and the second planar surface may be parallel with respect to each other. Also, the first curved surface may extend from the first planar surface and the second planar surface. Similarly, the second curved surface may extend from the first planar surface and the second planar surface. As non-limiting examples, the second operation may include stamping or extruding the metal sheet.

At block 2306, a first end of the metal sheet is secured with a second end of the metal sheet. The first end and the second end may align with each other, and may be secured together by welding, as a non-limiting example. Subsequent to securing the first end with the second end, the wound battery cell may be provided within a housing formed by the metal sheet.

FIG. 27 illustrates a flow diagram showing an alternate example of a process 2400 that may be performed for forming a battery cell, in accordance with one or more implementations of the present disclosure.

At block 2402, a contoured housing having at least two planar portions and at least two curved portions is provided. For example, the contoured housing may be formed by the proceed described herein in connection with FIG. 26. In one or more implementations, the planar portions are parallel, or at least substantially parallel, with respect to each other. The curved portions may extend from the planar portions. As a non-limiting example, each of the curved portions may form a semi-circular shape.

At block 2404, a wound electrode stack is provided into the contoured housing. The wound electrode stack may include one or more electrode layer rolled and positioned in the contoured housing.

At block 2406, a liquid electrolyte is provided into the contoured housing in which the wound electrode stack is disposed. The liquid electrolyte and the wound electrode stack may be used by the battery cell to generate electrical energy. Additionally, in one or more implementations, a cooling structure may be applied to one of the at least two curved portions.

Aspects of the subject technology can help improve the performance and reliability of battery cells such as prismatic battery cells. This can help facilitate the functioning, reliability, and/or proliferation of electric vehicles, which can positively impact the climate by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus, comprising:
a structural member for a battery cell, the structural member comprising a central support structure, a first flange at a first end of the central support structure, and a second flange at a second end of the central support structure, wherein the structural member is configured to receive a stack of electrodes within a cavity formed, in part, by the central support structure, a first portion of the first flange and a first portion of the second flange.

2. The apparatus of claim 1, wherein the structural member is configured to receive an additional stack of electrodes within an additional cavity formed, in part, by the central support structure, a second portion of the first flange and a second portion of the second flange.

3. The apparatus of claim 2, wherein the structural member is configured electrically couple the stack of electrodes to the additional stack of electrodes.

4. The apparatus of claim 1, wherein the structural member is configured to be electrically coupled to the stack of electrodes.

5. The apparatus of claim 1, wherein the central support structure of the structural member is configured to support a rolled stack of electrodes that wraps around the central support structure.

6. The apparatus of claim 1, wherein the first flange is configured to form a first surface of a cell housing for the battery cell, and wherein the second flange is configured to form a second surface of the cell housing for the battery cell.

7. The apparatus of claim 1, wherein the central support structure is formed from a thermally conductive material and is configured to conduct heat generated by the stack of electrodes away from the stack of electrodes.

8. The apparatus of claim 1, wherein the structural member comprises an I-beam that is formed from aluminum or steel.

9. A battery cell, comprising:
a structural member for a battery cell, the structural member comprising a central support structure, a first flange at a first end of the central support structure, and a second flange at a second end of the central support structure, wherein the structural member is configured to receive a stack of electrodes within a cavity formed, in part, by the central support structure, a first portion of the first flange and a first portion of the second flange.

10. The battery cell of claim 9, further comprising the stack of electrodes disposed at least partially within the cavity.

11. The battery cell of claim 10, further comprising an additional electrode stack disposed within an additional cavity formed, in part, by the central support structure, a second portion of the first flange and a second portion of the second flange.

12. The battery cell of claim 10, wherein the first flange is configured to form a first surface of a cell housing for the battery cell, the second flange is configured to form a second surface of the cell housing for the battery cell, and wherein the battery cell further comprises a housing structure attached to the structural member, wherein the housing structure forms at least a third surface of the cell housing.

13. An apparatus, comprising:
one or more wound electrode layers; and
a housing configured to conform to the one or more wound electrode layers, the housing comprising:
a first planar surface, and
a first curved surface extending from the first planar surface.

14. The apparatus of claim 13, wherein:
the housing further comprises a second planar surface, and
the first curved surface extends from the second planar surface.

15. The apparatus of claim 14, wherein the first planar surface is parallel with respect to the second planar surface.

16. The apparatus of claim 14, wherein:
the housing further comprises a second curved surface, and
the second curved surface extends from the second planar surface.

17. The apparatus of claim 16, wherein:
the first curved surface is configured to conform to a first portion of the one or more wound electrode layers, and
the second curved surface is configured to conform to a second portion of the one or more wound electrode layers.

18. The apparatus of claim 14, wherein the first curved surface comprises a semi-circle.

19. The apparatus of claim 18, wherein the first planar surface is separated from the second planar surface by a dimension that is twice a radius of the semi-circle.

20. The apparatus of claim 13, wherein the housing comprises:
a first dimension, and
a second dimension that is at least 30 times greater than the first dimension.
